(19) United States
(12) Patent Application Publication
(10) Pub. No.: US 2012/0307598 A1
(43) Pub. Date: Dec. 6, 2012

(54) ELECTRONIC APPARATUS AND ELECTRONIC TIMEPIECE

(76) Inventor: Takanori HASEGAWA, Chiba-shi (JP)

(21) Appl. No.: 13/479,811

(22) Filed: May 24, 2012

(30) Foreign Application Priority Data
Jun. 6, 2011 (JP) 2011-126588

(51) Int. Cl. H05B 37/02; G04B 19/00

(52) U.S. Cl. 368/66; 315/134

(57) ABSTRACT

A power generating unit generates electric power according to light incident on a light-receiving surface. A power storage unit stores the electric power generated by the power generating unit and outputs the stored electric power. A generated-power voltage detecting unit detects the voltage of the electric power generated by the power generating unit. A stored electricity voltage detecting unit detects the voltage output from the power storage unit. A display unit displays a character or an image. The display control unit changes contents to be displayed on the display unit on the basis of the voltage of the electric power generated by the power generating unit, which is detected by the generated-power voltage detecting unit, and the voltage of the electric power output from the power storage unit, which is detected by the stored electricity voltage detecting unit.

### BACKGROUND OF THE INVENTION

1. Technical Field

The present invention relates to an electronic apparatus and an electronic timepiece.

2. Description of the Related Art

In the related art, in an electronic timepiece including: a power generating unit, a time-count control unit configured to be driven upon reception of supply of electric energy from the power generating unit, a display unit configured to display time-of-day by driving of the time-count control unit, a detecting unit configured to detect the state of the power generating unit, and a determining unit configured to determine whether or not the power generating unit generates power on the basis of a detection signal from the detecting unit, and is provided with a power generating function configured to cause the display unit to display the state of power generation on the basis of the determination made by the determining unit, there is a known electronic timepiece including a power storage unit configured to store electric energy generated by the power generating unit and supply the energy to the time-count control unit, and a stored power detecting unit configured to detect a power storage state of the electric energy stored in the power storage unit, and being provided with a power generating function wherein a normal time-of-day display is performed when an absolute value of an amount of electric energy generated by the power generating unit is larger than a predetermined value, and a time-of-day display different from the normal time-of-day display is performed when the absolute value of the amount of electric energy generated by the power generating unit is smaller than the above-described value, and an absolute value of an amount of electric energy stored in the power storage unit is larger than the predetermined value, and part or the entire part of a time-of-day display operation performed by the time-count control unit is stopped when the absolute value of the amount of electric energy stored in the power storage unit is smaller than the predetermined value (for example, see Japanese Patent No. 4481497).

However, since the electronic timepiece known in the related art performs always the normal time-of-day display when the absolute value of the amount of electric energy generated by the power generating unit is larger than the predetermined value, the amount of electric energy stored in the power storage unit cannot be known by an user. Therefore, there is a problem in that the user cannot know whether or not power charging of the power storage unit should be preformed while recognizing which one of the generated power generated by the power generating unit and output power from the power storage unit is used.

### SUMMARY OF THE INVENTION

It is an aspect of the present application to provide an electronic apparatus and an electronic timepiece configured to let a user know whether or not charging of the power storage unit should be performed while letting the user know which one of power generated by a power generating unit and power output from a power storage unit is used.

The application provides an electronic apparatus including: a power generating unit configured to generate electric power according to light incident on a light-receiving surface; a power storing unit configured to store the electric power generated by the power generating unit and output the stored power; a generated power voltage detecting unit configured to detect a voltage of the electric power generated by the power generating unit; a stored power voltage detecting unit configured to detect a voltage of the electric power output from the power storage unit; a display unit configured to display a character and a graphic; and a display control unit configured to change contents to be displayed on the display unit on the basis of the voltage of the electric power generated by the power generating unit detected by the generated power voltage detecting unit and the voltage of the electric power output from the power storage unit detected by the stored power voltage detecting unit.

Preferably, the display control unit changes the contents to be displayed on the display unit on the basis of whether or not the voltage of the electric power generated by the power generating unit is not lower than voltage which can charge the power charging unit.

Preferably, the application includes a timepiece unit configured to output information indicating time of day and the display control unit changes the contents to be displayed on the display unit on the basis of whether or not the voltage of the electric power output from the power storage unit is equal to or higher than a voltage which is sufficient for controlling the display unit to display the time of day on the basis of the information indicating the time of day.

Preferably, the display control unit causes the display unit to display the time of day when the voltage of the electric power output from the power storage unit is not lower than a voltage sufficient for controlling the display unit to display the time of day on the basis of the information indicating the time of day, and does not cause the display unit to display the time of day when the voltage of the electric power output from the power storage unit is lower than the voltage which is sufficient for displaying the time of day on the basis of the information indicating the time of day.

Preferably, the display control unit causes the display unit to display a character or a graphic indicating the fact that the power storage unit may be charged when the voltage of the electric power generated by the power generating unit is not lower than the voltage which can charge the power charging unit.

Preferably, the display control unit changes the shape of the character or the graphic indicating the fact that the power storage unit may be charged according to the amount of electric power generated by the power generating unit.

Preferably, the display control unit changes a method of display for displaying the time of day according to the amount of electric power generated by the power generating unit.

Preferably, the display control unit changes the contrast of contents to be displayed on the display unit on the basis of the voltage of the electric power generated by the power generating unit detected by the generated power voltage detecting unit and the voltage of the electric power output from the power storage unit detected by the stored power voltage detecting unit.

Preferably, the application provides an electronic timepiece including: a power generating unit configured to generate electric power according to light incident on a light-receiving surface; a power storing unit configured to store electric power generated by the power generating unit and output the stored power; a generated power voltage detecting unit configured to detect a voltage of the electric power generated by the power generating unit; a stored power voltage detecting unit configured to detect a voltage of the electric power output from the power storage unit; a timepiece unit configured to output information indicating time of day; a display unit configured to display a time-of-day, a character and a graphic; and a display control unit configured to change contents to be displayed on the display unit on the basis of the voltage of the electric power generated by the power generating unit detected by the generated power voltage detecting unit and the voltage of the electric power output from the power storage unit detected by the stored power voltage detecting unit.

According to the application, the power generating unit generates the electric power according to the light incident on the light-receiving surface. Also, the power storage unit stores electric power generated by the power generating unit and outputs the stored electric power. The generated-power voltage detecting unit detects the voltage of the electric power generated by the power generating unit. The stored power voltage detecting unit detects the voltage of the electric power output by the power storage unit. The display unit displays the character or the image. The display control unit changes contents to be displayed on the display unit on the basis of the voltage of the electric power generated by the power generating unit, which is detected by the generated-power voltage detecting unit, and the voltage of the electric power output from the power storage unit, which is detected by the stored electricity voltage detecting unit. Accordingly, the contents to be displayed by the display unit are based on the contents to be displayed on the basis of the voltage of the power generated by the power generating unit and the voltage of the power output from the power storage unit. Therefore, whether or not the power storage unit should be charged may be informed to the user while letting the user know which one of the electric power generated by the power generating unit and the electric power output from the power storage unit is used for the operation between.

### BRIEF DESCRIPTION OF THE DRAWINGS

FIG. 1 is a block diagram showing a configuration of an electronic timepiece according to a first embodiment of the invention;

FIG. 2 is a schematic view showing a display screen displayed on a display unit when a voltage of electric power output from a power storage unit is equal to or higher than a first predetermined voltage and a voltage of electric power generated by a power generating unit is equal to or higher than a second predetermined voltage in the embodiment;

FIG. 3 is a schematic view showing the display screen displayed on the display unit when the voltage of the electric power output from the power storage unit is equal to or higher than the first predetermined voltage and the voltage of the electric power generated by a power generating unit is lower than the second predetermined voltage in the embodiment;

FIG. 4 is a schematic view showing the display screen displayed on the display unit when the voltage of the electric power output from the power storage unit is lower than the first predetermined voltage and the voltage of the electric power generated by the power generating unit is equal to or higher than the second predetermined voltage, or the voltage of the electric power output from the power storage unit is lower than the first predetermined voltage and the voltage of the electric power generated by the power generating unit is lower than the second predetermined voltage in the embodiment;

FIG. 5 is a schematic view showing the display screen displayed on the display unit when the voltage of electric power output from the power storage unit is lower than the first predetermined voltage and the voltage of electric power generated by the power generating unit is equal to or higher than the second predetermined voltage in the embodiment;

FIG. 6 is a schematic view showing the display screen displayed on the display unit when the voltage of electric power output from the power storage unit is lower than the first predetermined voltage and the voltage of electric power generated by the power generating unit is lower than the second predetermined voltage in the embodiment;

FIGS. 7A to 7D are schematic views showing a display of a sun mark when the display is changed according to an amount of electric power generated by the power generating unit in the embodiment;

FIGS. 8A to 8D are schematic views showing the display of the sun mark when the display is changed according to the amount of electric power generated by the power generating unit in the embodiment;

FIG. 9 is a schematic view showing a display screen displayed by the display unit when the contrast of characters or images displayed on the display unit is changed according to the amount of electric power generated by the power generating unit in the embodiment;

FIG. 10 is a schematic view showing the display screen displayed by the display unit when the contrast of characters or images displayed on the display unit is changed according to the amount of electric power generated by the power generating unit in the embodiment;

FIGS. 11A to 11D are schematic views showing the display screen displayed by the display unit when the contrast of characters or images displayed on the display unit is changed according to the amount of electric power generated by the power generating unit and the amount of electric power stored in the power storage unit in the embodiment;

FIGS. 12A to 12E are schematic views showing an example of display of a time-of-day display when the display is changed according to the amount of electric power generated by the power generating unit in the embodiment; and

FIGS. 13A and 13B are schematic views showing an example of display of a time-of-day display when the display is changed according to the amount of electric power generated by the power generating unit in the embodiment.

### DETAILED DESCRIPTION OF THE PREFERRED EMBODIMENTS

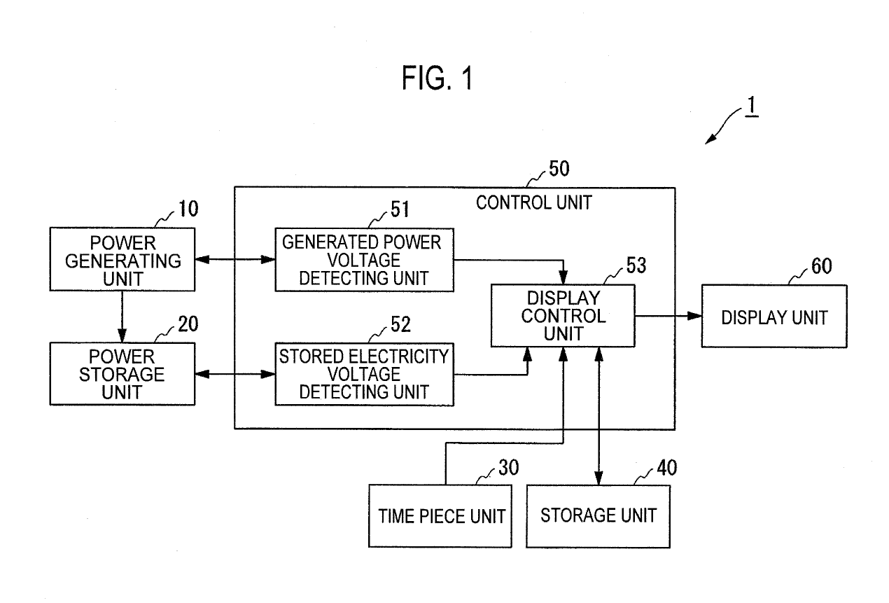

Referring now to the drawings, an embodiment of the invention will be described. In this embodiment, an example of an electronic timepiece provided with a power generating unit is used for description as an example of the electronic apparatus. FIG. 1 is a block diagram showing a configuration of an electronic timepiece 1 (electronic apparatus) in this embodiment. In the illustrated example, the electronic timepiece 1 includes a power generating unit 10, a power storage unit 20, a timepiece unit 30, a storage unit 40, a control unit 50, and a display unit 60.

The power generating unit 10 is a solar cell provided with a light-receiving surface configured to receive light and charge the power storage unit 20 by generating electric power according to the received (incident) light. The power storage unit 20 is a rechargeable secondary cell and configured to charge electric power generated by the power generating unit 10. The power storage unit 20 is configured to output (supply) the charged electric power to respective parts of the electronic timepiece 1. The timepiece unit 30 outputs information indicating current time of day. The storage unit 40 is a ROM (Read Only Memory) or a RAM (Random Access Memory), and stores a program executed by a control unit 50 or data used by the electronic timepiece 1.

The control unit 50 controls the respective parts of the electronic timepiece 1. The control unit 50 includes a generated power voltage detecting unit 51, a stored power voltage detecting unit 52, and a display control unit 53. The generated power voltage detecting unit 51 is configured to detect an amount of electric power generated by the power generating unit 10 on the basis of an voltage of electric power generated by the power generating unit 10 and the voltage of the electric power generated by the power generating unit 10. The stored power voltage detecting unit 52 is configured to detect an amount of electric power stored by the power storage unit 20 on the basis of an voltage of electric power output from the power storage unit 20 and the voltage of the electric power output from the power storage unit 20. The display control unit 53 controls the display unit 60 and displays characters or images on the display unit 60. In this embodiment, the display control unit 53 changes contents to be displayed on the display unit 60 on the basis of the voltage of the electric power generated by the power generating unit 10, which is detected by the generated power voltage detecting unit 51, and the voltage of the electric power output from the power storage unit 20, which is detected by the stored power voltage detecting unit 52. The detailed example will be described later. The display unit 60 displays the characters and the images on the basis of the control of the display control unit 53.

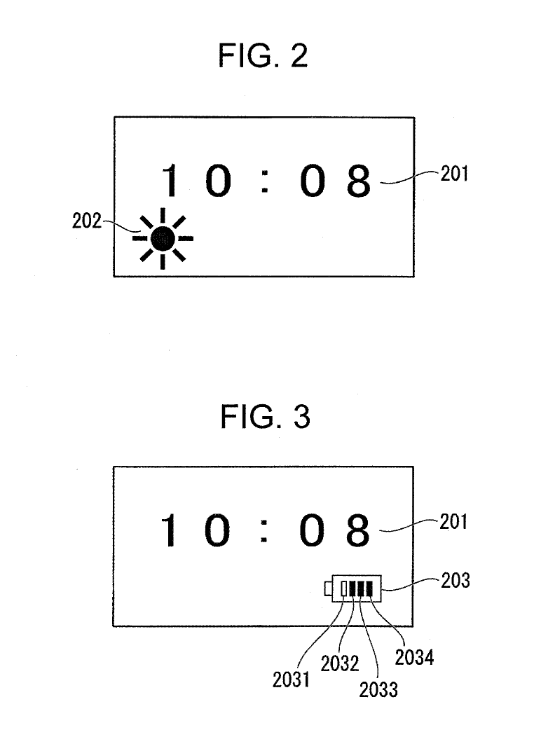

Subsequently, the display screen displayed by the display unit 60 on the basis of the control of the display control unit 53 will be described. FIG. 2 is a schematic view showing the display screen displayed on the display unit 60 when the voltage of electric power output from the power storage unit 20 is equal to or higher than a first predetermined voltage and the voltage of electric power generated by the power generating unit 10 is equal to or higher than a second predetermined voltage in this embodiment. In the example shown in FIG. 2, the display unit 60 displays a time-of-day display 201 on an upper portion of the display screen and a sun mark 202 on a lower left portion of the display screen.

The first predetermined voltage is a lower limit voltage which allows the timepiece unit 30 to output information indicating the current time of day and the display control unit 53 to cause the display unit 60 to display the time of day (time-of-day displaying operation) on the basis of the information indicating the current time of day output from the timepiece unit 30. The second predetermined voltage is a lower limit voltage which can charge the power storage unit 20. In other words, when the voltage of electric power output from the power storage unit 20 is equal to or higher than the first predetermined voltage, the electronic timepiece 1 may perform the operation to display the time of day, and when the voltage of the electric power output from the power storage unit 20 is lower than the predetermined first voltage, the electronic timepiece 1 cannot perform the operation to display the time of day. Even when the voltage of the electric power output from the power storage unit 20 is lower than the predetermined voltage, when the voltage is equal to or higher than a voltage which allows a minimum display on the display unit 60 (a stop voltage), the electronic timepiece 1 is capable of displaying the images or the characters on the display unit 60. Also, when the voltage of the electric power generated by the power generating unit 10 is equal to or higher than the second predetermined voltage, the power storage unit 20 may be charged, and when the voltage of the electric power generated by the power generating unit 10 is lower than the second predetermined voltage, the power storage unit 20 cannot be charged.

When the voltage of the electric power output by the power storage unit 20 is equal to or higher than the first predetermined voltage and the voltage of the electric power generated by the power generating unit 10 is equal to or higher than the second predetermined voltage, that is, when the power storage unit 20 is sufficiently charged and hence the power storage unit 20 may be charged with the electric power generated by the power generating unit 10, the electronic timepiece 1 is operated by using the electric power generated by the power generating unit 10. In this case, the display control unit 53 of the electronic timepiece 1 controls the display unit 60 and, as shown in FIG. 2, the time-of-day display 201 and the sun mark 202 are displayed on the display unit 60. Therefore, by confirming the display, the user may recognize the fact that the electronic timepiece 1 is operated by using the electric power generated by the power generating unit 10 and, in addition, since sufficient power is stored in the power storage unit 20, the user may recognize the fact that the power storage unit 20 is not necessary to be charged.

FIG. 3 is a schematic view showing the display screen displayed on the display unit 60 when the voltage of electric power output from the power storage unit 20 is equal to or higher than the first predetermined voltage and the voltage of electric power generated by the power generating unit 10 is lower than the second predetermined voltage in this embodiment. In the example shown in FIG. 3, the display unit 60 displays a time-of-day display 201 on an upper portion of the display screen and a battery mark 203 on a lower right portion of the display screen. When the voltage of the electric power output by the power storage unit 20 is equal to or higher than the first predetermined voltage and the voltage of the electric power generated by the power generating unit 10 is lower than the second predetermined voltage, that is, when the power storage unit 20 is sufficiently charged but the power storage unit 20 cannot be charged with the electric power generated by the power generating unit 10, the electronic timepiece 1 is operated using the electric power output from the power storage unit 20. In this case, the electronic timepiece 1 displays the time-of-day display 201 and the battery mark 203 on the display unit 60 as illustrated in FIG. 3. Therefore, by confirming the display, the user may recognize the fact that the electronic timepiece 1 is operated by using the electric power output from the power storage unit 20 and, in addition, since sufficient power is stored in the power storage unit 20, the user may recognize the fact that the power storage unit 20 is not necessary to be charged.

The amount of storage of the power storage unit 20 may be informed to the user in further detail by changing the display of the battery mark 203 according to the amount of storage of the power storage unit 20. For example, the amount of electric power stored in the power storage unit 20 is classified into four stages of 75% to 100%, 50% to 75%, 25% to 50%, and 0% to 25% of the maximum amount of storage of the electric power and the display of the remaining amount displays 2031 to 2034 of the battery mark 203 is changed depending on the classifications. The conditions of the classification are not limited to the classifications described above, and may be set arbitrarily. The stored power voltage detecting unit 52 detects the amount of the electric power stored in the power storage unit 20 and the display control unit 53 controls the display of the battery mark 203 displayed on the display unit 60 on the basis of the amount of the electric power stored in the storage unit 20.

FIG. 4 is a schematic view showing a display screen displayed on the display unit 60 when the voltage of electric power output from the power storage unit 20 is lower than the first predetermined voltage and the voltage of electric power generated by the power generating unit 10 is equal to or higher than the second predetermined voltage, or the voltage of the electric power output from the power storage unit 20 is lower than the first predetermined voltage and the voltage of the electric power generated by the power generating unit 10 is lower than the second predetermined voltage. In the example shown in FIG. 4, the sun mark 202 is displayed on the lower left portion of the display screen in an blinking manner by the display unit 60.

When the voltage of the electric power output from the power storage unit 20 is lower than the first predetermined voltage and the voltage of the electric power generated by the power generating unit 10 is equal to or higher than the second predetermined voltage, that is, when the sufficient power which allows the electronic timepiece 1 to perform the time-of-day display operation is not stored in the power storage unit 20 but the power storage unit 20 may be charged by the electric power generated by the power generating unit 10, the electronic timepiece 1 charges the power storage unit 20 with the electric power generated by the power generating unit 10. In this case, the electronic timepiece 1 displays the sun mark 202 on the display unit 60 in a blinking manner as shown in FIG. 4. When the voltage of the electric power output from the power storage unit 20 is lower than the first predetermined voltage and the voltage of the electric power generated by the power generating unit 10 is lower than the second predetermined voltage, that is, when the sufficient power which allows the electronic timepiece 1 to perform the time-of-day display operation is not stored in the power storage unit 20 and hence the power storage unit 20 cannot be charged by the electric power generated by the power generating unit 10, the electronic timepiece 1 displays the sun mark 202 on the display unit 60 in a blinking manner as shown in FIG. 4.

Therefore, the user may recognize the fact that the electronic timepiece 1 cannot perform the time-of-day display operation by confirming the display shown in FIG. 4, and since the amount of electric power sufficient for the electronic timepiece 1 to perform the time-of-day display operation is not stored in the power storage unit 20, the user may recognize the fact that the power storage unit 20 needs to be charged.

The display screen displayed on the display unit 60 when the voltage of electric power output from the power storage unit 20 is lower than the first predetermined voltage and the voltage of electric power generated by the power generating unit 10 is equal to or higher than the predetermined voltage, and the display screen displayed on the display unit 60 when the voltage of the electric power output from the power storage unit 20 is lower than the first predetermined voltage and the voltage of the electric power generated by the power generating unit 10 is lower than the second predetermined voltage may be different display screens.

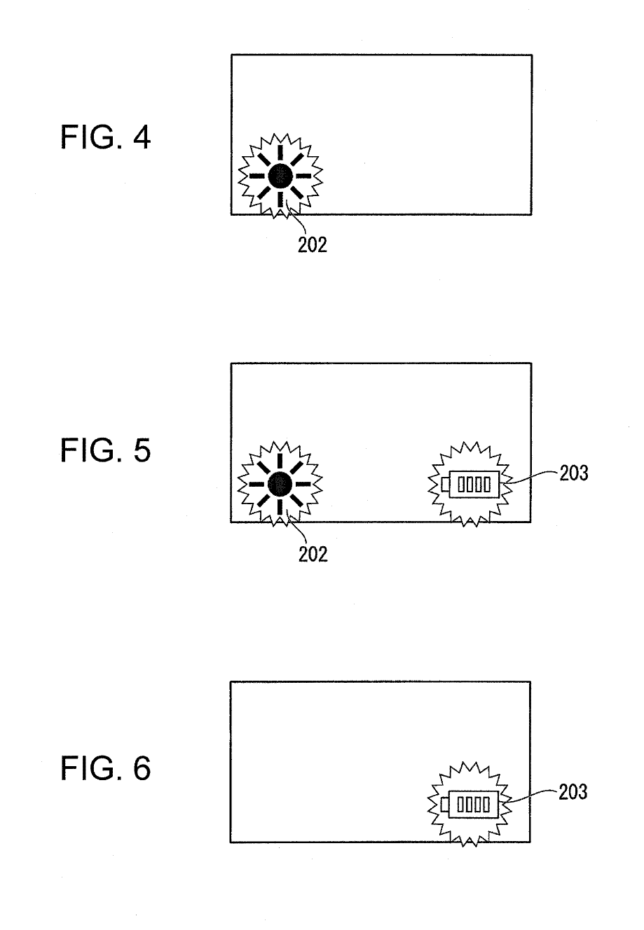

FIG. 5 is a schematic view showing the display screen displayed on the display unit 60 when the voltage of electric power output from the power storage unit 20 is lower than the first predetermined voltage and the voltage of electric power generated by the power generating unit 10 is equal to or higher than the second predetermined voltage in this embodiment. In the example shown in FIG. 5, the display unit 60 displays the sun mark 202 on the lower left portion of the display screen in a blinking manner and the battery mark 203 on a lower right portion of the display screen in a blinking manner. When the voltage of the electric power output from the power storage unit 20 is lower than the first predetermined voltage and the voltage of the electric power generated by the power generating unit 10 is equal to or higher than the second predetermined voltage, that is, when the sufficient power which allows the electronic timepiece 1 to perform the time-of-day display operation is not stored in the power storage unit 20 but the power storage unit 20 can be charged by the electric power generated by the power generating unit 10, the electronic timepiece 1 charges the power storage unit 20 with the electric power generated by the power generating unit 10. In this case, the electronic timepiece 1 displays the sun mark 202 and the battery mark 203 on the display unit 60 in a blinking manner as illustrated in FIG. 5. Therefore, the user may recognize that the power storage unit 20 should be charged because the amount of electric power sufficient for the electric timepiece 1 to perform the time-of-day display operation is not stored in the power storage unit 20, but the power storage unit 20 is charged with the electric power generated by the power generating unit 10 by confirming this display.

FIG. 6 is a schematic view showing the display screen displayed on the display unit 60 when the voltage of electric power output from the power storage unit 20 is lower than the first predetermined voltage and the voltage of electric power generated by the power generating unit 10 is lower than the second predetermined voltage in this embodiment. In the example shown in FIG. 6, the battery mark 203 is displayed on the lower right portion of the display screen in an blinking manner by the display unit 60. When the voltage of the electric power output from the power storage unit 20 is lower than the first predetermined voltage and the voltage of the electric power generated by the power generating unit 10 is lower than the second predetermined voltage, that is, when the sufficient power which allows the electronic timepiece 1 to perform the time-of-day display operation is not stored in the power storage unit 20 and hence the power storage unit 20 cannot be charged by the electric power generated by the power generating unit 10, the electronic timepiece 1 displays the battery mark 203 on the display unit 60 in a blinking manner as shown in FIG. 6. Therefore, the user may recognize that the power storage unit 20 should be charged because the amount of electric power sufficient for the electronic timepiece 1 to perform the time-of-day display operation is not stored in the power storage unit 20, but the power storage unit 20 cannot be charged with the electric power generated by the power generating unit 10 by confirming this display. Accordingly, the user may recognize the fact that the electronic timepiece 1 should be moved to a place getting light such as the sun in order to use the electronic timepiece 1.

As described above, according to this embodiment, the generated power voltage detecting unit 51 detects the voltage of the electric power generated by the power generating unit 10 and the stored power voltage detecting unit 52 detects the voltage of the electric power output by the power storage unit 20. Also, the display control unit 53 changes contents to be displayed on the display unit 60 on the basis of the voltage of the electric power generated by the power generating unit 10, which is detected by the generated power voltage detecting unit 51, and the voltage of the electric power output from the power storage unit 20, which is detected by the stored power voltage detecting unit 52, as shown in FIGS. 2 to 6. Therefore, the electronic timepiece 1 may let the user know whether or not the power storage unit 20 should be charged while letting the user know whether the electric power generated by the power generating unit 10 is used for the operation or the power charged by the power storage unit 20 is used for the operation. Also, since the electronic timepiece 1 uses only the display elements such as the time-of-day display 201, the sun mark 202, and the battery mark 203, the power consumption is lower than the case of using a number of display elements, and hence the electronic timepiece 1 may let the user know whether or not the power storage unit 20 should be charged while letting the user know whether the electric power generated by the power generating unit 10 is used for the operation or the power charged by the power storage unit 20 is used for the operation.

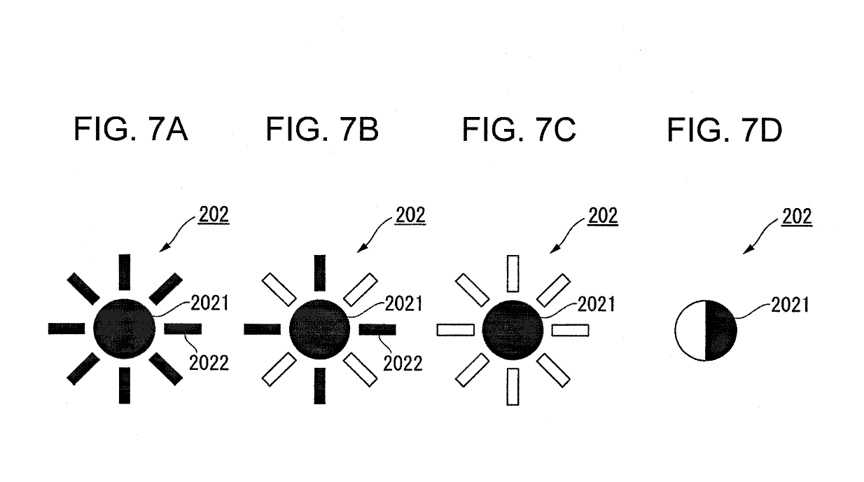

For reference, the amount of electric power generated by the power generating unit 10 may be informed to the user in further detail by changing the display of the sun mark 202. FIGS. 7A to 7D are schematic views showing the display of the sun mark 202 when the display is changed according to the amount of electric power generated by the power generating unit 10 in the embodiment. In the illustrated example, the amount of electric power generated by the power generating unit 10 is classified into four stages of 75% to 100%, 50% to 75%, 25% to 50%, and 0% to 25% of the maximum amount of the electric power generation and the display is changed depending on the classifications. The conditions of the classifications are not limited to the classification described above, and may be set arbitrarily. For reference, the generated power voltage detecting unit 51 detects the amount of electric power generated by the power generating unit 10 and the display control unit 53 controls the display of the sun mark 202 displayed on the display unit 60 on the basis of the amount of the electric power generated by the power generating unit 10.

FIG. 7A shows the sun mark 202 displayed by the display unit 60 when the amount of electric power generated by the power generating unit 10 falls within a range from 75% to 100% of the maximum amount of electric power generation. In the illustrated example, the sun mark 202 is displayed entirely. FIG. 7B shows the sun mark 202 displayed by the display unit 60 when the amount of electric power generated by the power generating unit 10 falls within a range from 50% to 75% of the maximum amount of electric power generation. In the illustrated example, a circular portion 2021 and rectangular portions displayed above, below, left and right of the circular portion 2021 of the sun mark 202 are displayed. FIG. 7C shows the sun mark 202 displayed by the display unit 60 when the amount of electric power generated by the power generating unit 10 falls within the range from 25% to 50% of the maximum amount of electric power generation. In the illustrated example, only the circular portion 2021 of the sun mark 202 is displayed. FIG. 7D shows the sun mark 202 displayed by the display unit 60 when the amount of electric power generated by the power generating unit 10 falls within the range from 0% to 25% of the maximum amount of electric power generation. In the illustrated example, only the right half of the circular portion 2021 of the sun mark 202 is displayed.

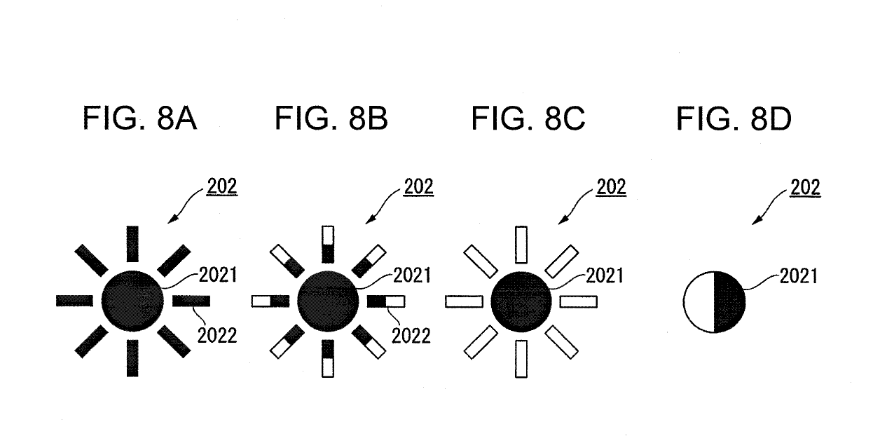

The invention is not limited to the contents of display shown in FIGS. 7A to 7D, and a configuration in which the amount of electric power generated by the power generating unit 10 may be informed to the user in further detail by changing the display of the sun mark 202 is also applicable. FIGS. 8A to 8D are schematic views showing the display of the sun mark 202 when the display is changed according to the amount of electric power generated by the power generating unit 10 in the embodiment. FIG. 8A shows the sun mark 202 displayed by the display unit 60 when the amount of electric power generated by the power generating unit 10 falls within the range from 75% to 100% of the maximum amount of electric power generation. In the illustrated example, the sun mark 202 is displayed entirely. FIG. 8B shows the sun mark 202 displayed by the display unit 60 when the amount of electric power generated by the power generating unit 10 falls within the range from 50% to 75% of the maximum amount of electric power generation. In the illustrated example, the entire circular portion 2021 and respective halves of the rectangular portions 2022 displayed around the circular portion 2021 of the sun mark 202 are displayed. FIG. 8C shows the sun mark 202 displayed by the display unit 60 when the amount of electric power generated by the power generating unit 10 falls within the range from 25% to 50% of the maximum amount of electric power generation. In the illustrated example, only the circular portion 2021 of the sun mark 202 is displayed. FIG. 8D shows the sun mark 202 displayed by the display unit 60 when the amount of electric power generated by the power generating unit 10 falls within the range from 0% to 25% of the maximum amount of electric power generation. In the illustrated example, only the right half of the circular portion 2021 of the sun mark 202 is displayed.

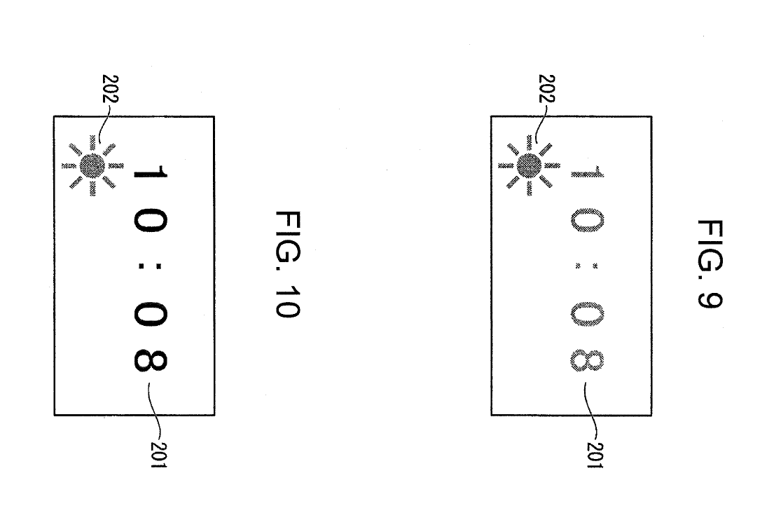

The amount of electric power generated by the power generating unit 10 may be informed to the user by changing the contrast of the characters or the images displayed on the display unit 60. FIG. 9 and FIG. 10 are schematic views showing a display screen displayed by the display unit 60 when the contrast of characters or images displayed on the display unit 60 is changed according to the amount of electric power generated by the power generating unit 10 in the embodiment. In the illustrated example, a display screen displayed by the display unit 60 when the amount of electric power generated by the power generating unit 10 is classified into two stages of 50% to 100% and 0% to 50% of the maximum amount of electric power generation and the amount of electric power generated by the power generating unit 10 falls in a range from 0% to 50% of the maximum amount of electric power generation. The conditions of the classifications are not limited to the classification described above, and may be set arbitrarily. For reference, the generated power voltage detecting unit 51 detects the amount of electric power generated by the power generating unit 10 and the display control unit 53 controls the contrast of the characters or images displayed on the display unit 60 on the basis of the amount of the electric power generated by the power generating unit 10.

In the example shown in FIG. 9, when the amount of electric power generated by the power generating unit 10 falls within the range from 0% to 50% of the maximum amount of electric power generation, the contrast of the time-of-day display 201 and the sun mark 202 is displayed to be low. In the example shown in FIG. 10, when the amount of electric power generated by the power generating unit 10 falls within the range from 0% to 50% of the maximum amount of electric power generation, the contrast of only the sun mark 202 is displayed to be low. When the amount of the electric power generating unit 10 falls within the range from 50% to 100% of the maximum amount of electric power generation, the contrast of the time-of-day display 201 and the sun mark 202 is displayed to be high as shown in FIG. 2.

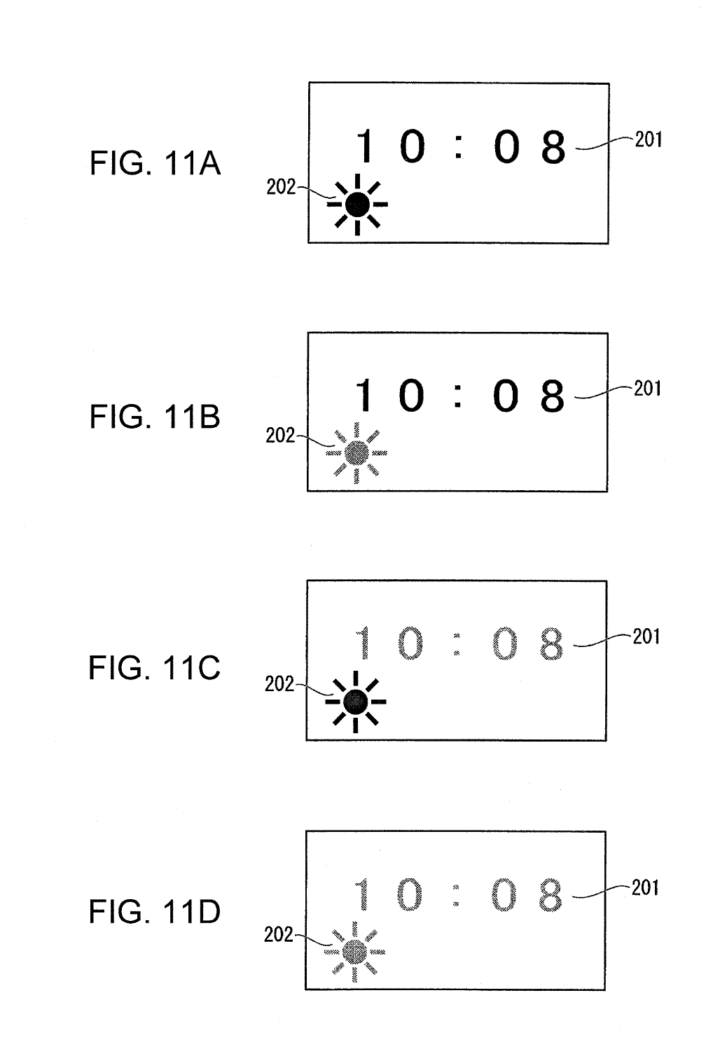

The amount of electric power generated by the power generating unit 10 and the amount of electric power stored in the power storage unit 20 may be informed to the user by changing the contrast of the characters or the images displayed on the display unit 60. FIGS. 11A to 11D are schematic views showing the display screen displayed by the display unit 60 when the contrast of characters or images displayed on the display unit 60 is changed according to the amount of electric power generated by the power generating unit 10 and the amount of electric power stored in the power storage unit 20 in the embodiment. In the illustrated example, a display screen displayed by the display unit 60 according to the combination of classifications determined by classifying the amount of electric power generated by the power generating unit 10 into two stages of 50% to 100% and 0% to 50% of the maximum amount of electric power generation and the amount of electric power stored in the power storing unit 20 into two classifications of 50% to 100% and 0% to 50% of the maximum amount of electric power storage. The conditions of the classifications are not limited to the classification described above, and may be set arbitrarily. For reference, the generated power voltage detecting unit 51 detects the amount of electric power generated by the power generating unit 10 and the stored power voltage detecting unit 52 detects the amount of electric power stored in the power storage unit 20, and the display control unit 53 controls the contrast of the characters or images displayed on the display unit 60 on the basis of the amount of the electric power generated by the power generating unit 10 and the amount of electric power stored in the power storage unit 20.

Specifically, when the amount of electric power generated by the power generating unit 10 falls within the range from 50% to 100% of the maximum amount of electric power generation, the contrast of the sun mark 202 is displayed to be high, and when the amount of electric power generated by the power generating unit 10 falls within the range from 0% to 50% of the maximum amount of electric power generation, the contrast of the sun mark 202 is displayed to be low. When the amount of electric power stored in the power storage unit 20 falls within the range from 50% to 100% of the maximum amount of stored power, the contrast of the time-of-day display 201 is displayed to be high, and when the amount of electric power stored in the power storage unit 20 falls within the range from 0% to 50% of the maximum amount of electric power storage, the contrast of the time-of-day display 201 is displayed to be low. For reference, the generated power voltage detecting unit 51 detects the amount of electric power generated by the power generating unit 10 and the stored power voltage detecting unit 52 detects the amount of electric power stored in the power storage unit 20, and the display control unit 53 controls the contrast of the characters or images displayed on the display unit 60 on the basis of the amount of the electric power generated by the power generating unit 10 and the amount of electric power stored in the power storage unit 20. In this manner the power consumption may be reduced by lowering the contrast.

FIGS. 11A to 11D show a display screen displayed by the display unit 60 when the amount of electric power generated by the power generating unit 10 is 50% to 100% of the maximum amount of electric power generation and the amount of electric power stored in the power storage unit 20 falls within the range from 50% to 100% of the maximum amount of stored power. In the illustrated example, the contrast of the time-of-day display 201 and the sun mark 202 is displayed to be high. FIG. 11B shows a display screen displayed by the display unit 60 when the amount of electric power generated by the power generating unit 10 falls within the range from 0% to 50% of the maximum amount of electric power generation and the amount of electric power stored in the power storage unit 20 falls within the range from 50% to 100% of the maximum amount of stored power. In the illustrated example, the contrast of the time-of-day display 201 is displayed to be high and the contrast of the sun mark 202 is displayed to be low. FIG. 11C shows a display screen displayed by the display unit 60 when the amount of electric power generated by the power generating unit 10 falls within the range from 50% to 100% of the maximum amount of electric power generation and the amount of electric power stored in the power storage unit 20 falls within the range from 0% to 50% of the maximum amount of stored power. In the illustrated example, the contrast of the time-of-day display 201 is displayed to be low and the contrast of the sun mark 202 is displayed to be high. FIG. 11D shows a display screen displayed by the display unit 60 when the amount of electric power generated by the power generating unit 10 falls within the range from 0% to 50% of the maximum amount of electric power generation and the amount of electric power stored in the power storage unit 20 falls within the range from 0% to 50% of the maximum amount of stored power. In the illustrated example, the contrast of the time-of-day display 201 and the sun mark 202 is displayed to be low.

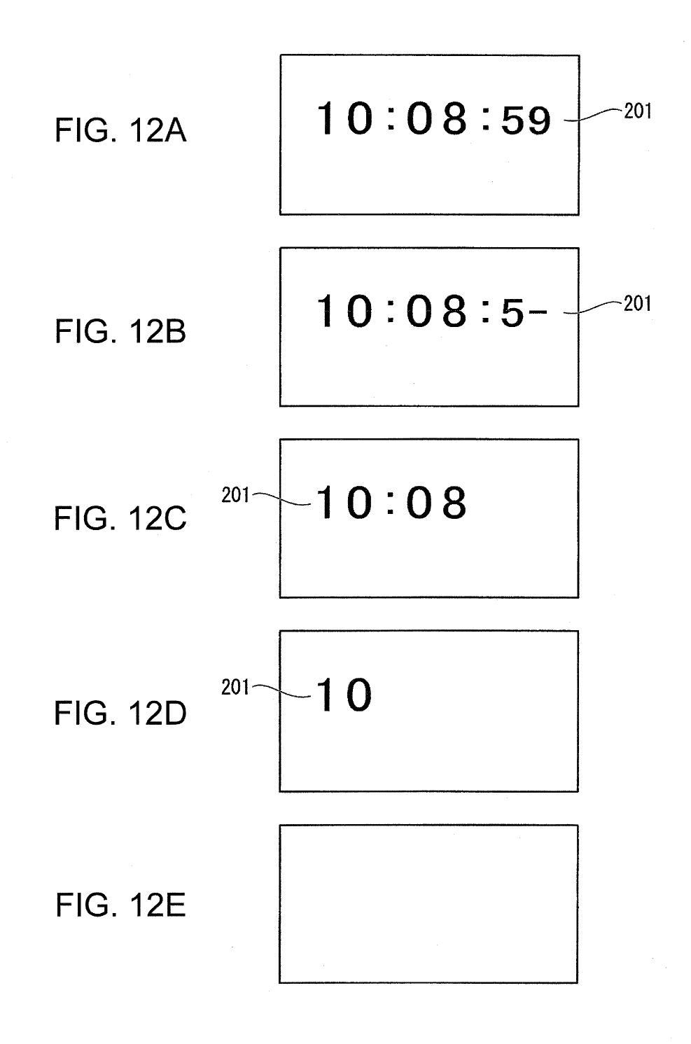

The amount of electric power generated by the power generating unit 10 may be informed to the user by changing the content of the time-of-day display 201 displayed on the display unit 60. FIGS. 12A to 12E are schematic views showing an example of the display of the time-of-day display 201 when the display is changed according to the amount of electric power generated by the power generating unit 10 in the embodiment. In the illustrated example, the amount of electric power generated by the power generating unit 10 is classified into five stages of 80% to 100%, 60% to 80%, 40% to 60%, 20% to 40%, and 0% to 20% of the maximum amount of electric power generation and the contents to be displayed of the time-of-day display 201 is changed depending on the classifications. The conditions of the classifications are not limited to the classification described above, and may be set arbitrarily. For reference, the generated power voltage detecting unit 51 detects the amount of electric power generated by the power generating unit 10 and the display control unit 53 controls the display contents of the time-of-day display 201 displayed on the display unit 60 on the basis of the detected amount of the electric power generated by the power generating unit 10.

FIG. 12A shows the time-of-day display 201 displayed by the display unit 60 when the amount of electric power generated by the power generating unit 10 falls within the range from 80% to 100% of the maximum amount of the electric power generation. In the illustrated example, all of the hour, minute, and second of the time-of-day display 201 are displayed. FIG. 12B shows the time-of-day display 201 displayed by the display unit 60 when the amount of electric power generated by the power generating unit 10 falls within the range from 60% to 80% of the maximum amount of the electric power generation. In the illustrated example, the hour, minute, and value at the tenths place of second of the time-of-day display 201 are displayed, and a symbol “-” is displayed at the position of ones digit. FIG. 12C shows the time-of-day display 201 displayed by the display unit 60 when the amount of electric power generated by the power generating unit 10 falls within the range from 40% to 60% of the maximum amount of electric power generation. In the illustrated example, the hour and minute of the time-of-day display 201 are displayed, and the value of the second is turned off. FIG. 12D shows the time-of-day display 201 displayed by the display unit 60 when the amount of electric power generated by the power generating unit 10 falls within the range from 20% to 40% of the maximum amount of electric power generation. In the illustrated example, only the hour of the time-of-day display 201 is displayed, and the values of the minute and second are turned off. FIG. 12E shows the time-of-day display 201 displayed by the display unit 60 when the amount of electric power generated by the power generating unit 10 falls within the range from 0% to 20% of the maximum amount of electric power generation. In the illustrated example, all of the time-of-day display 201 is turned off. In this manner, the power consumption may be reduced by reducing the contents to be displayed of the time-of-day display 201. Also, the amount of electric power generation by the power generating unit 10 may be informed to the user without increasing the number of segments.

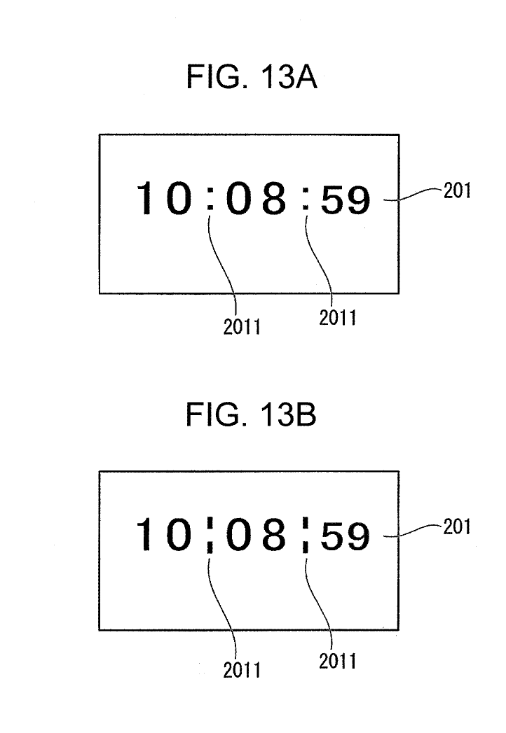

It is also possible to let the user know the amount of electric power generated by the power generating unit 10 in further detail by changing the shape (size) of the colons (:) which delimit positions between the values of the hour, minute, and second of the time-of-day display 201. FIGS. 13A and 13B are schematic views showing an example of the display of the time-of-day display 201 when the display is changed according to the amount of electric power generated by the power generating unit 10 in the embodiment. In the illustrated example, the amount of electric power generated by the power generating unit 10 is classified into two stages of 50% to 100% and 0% to 50% of the maximum amount of electric power generation and the shape (size) of the colons 2011 (:) which delimits the positions between the hour, minute, and second of the time-of-day display 201 is changed depending on the classifications. The conditions of the classifications are not limited to the classification described above, and may be set arbitrarily. For reference, the generated power voltage detecting unit 51 detects the amount of electric power generated by the power generating unit 10 and the display control unit 53 controls the display contents of the time-of-day 201 displayed on the display unit 60 by the display control unit 53 on the basis of the detected amount of the electric power generated by the power generating unit 10.

FIG. 13A shows the time-of-day display 201 displayed by the display unit 60 when the amount of electric power generated by the power generating unit 10 falls within the range from 50% to 100% of the maximum amount of electric power generation. In the illustrated example, the colons 2011 (:) which delimit the positions between the hour, minute, and second of the time-of-day display 201 are two square points arranged one above the other. FIG. 13B shows the time-of-day display 201 displayed by the display unit 60 when the amount of electric power generated by the power generating unit 10 falls within the range from 0% to 50% of the maximum amount of electric power generation. In the illustrated example, the colons 2011 (:) which delimit the positions between the hour, minute, and second of the time-of-day display 201 are two rectangular points arranged one above the other. In this case, what is to do is just to change the shape of the colons 2011, and hence the amount of electric power generation by the power generating unit 10 may be informed to the user without increasing the number of segments.

As described above, according to this embodiment, the generated power voltage detecting unit 51 detects the voltage of the electric power generated by the power generating unit 10 and the stored power voltage detecting unit 52 detects the voltage of the electric power output by the power storage unit 20. Also, the display control unit 53 changes contents to be displayed on the display unit 60 on the basis of the voltage of the electric power generated by the power generating unit 10, which is detected by the generated power voltage detecting unit 51, and the voltage of the electric power output from the power storage unit 20, which is detected by the stored power voltage detecting unit 52. Therefore, the electronic timepiece 1 may let the user know whether or not the power storage unit 20 should be charged while letting the user know whether the electric power generated by the power generating unit 10 is used for the operation or the power charged by the power storage unit 20 is used for the operation.

Also according to the embodiment, the generated power voltage detecting unit 51 detects the amount of electric power generated by the power generating unit 10. Also, the display control unit 53 changes contents to be displayed on the display unit 60 on the basis of the amount of electric power generated by the power generating unit 10, which is detected by the generated power voltage detecting unit 51. Therefore, the electronic timepiece 1 is capable of letting the user know the amount of electric power generated by the power generating unit 10 in further detail.

Also according to the embodiment, the stored power voltage detecting unit 52 detects the amount of electric power stored in the power storage unit 20. Also, the display control unit 53 changes contents to be displayed on the display unit 60 on the basis of the amount of electric power stored in the power generating unit 20, which is detected by the stored power voltage detecting unit 52. Therefore, the electronic timepiece 1 is capable of letting the user know the amount of electric power stored in the power storage unit 20.

The entire part or part of the functions of the respective part of the electronic timepiece 1 may be realized by recording a program for realizing these functions into a computer readable recording medium and causing a computer system to read the program recorded in the recording medium and executing the program. The “computer system” here includes an OS and hardware such as peripheral equipments.

The term “computer readable recording medium” means storage units including portable media such as flexible disks, magneto-optical disks, ROMs, CD-ROMs, and a hard disk integrated in the computer system. Furthermore, the term “computer readable recording medium” may include media which hold a program dynamically for a short time such as a communication line in a case of transmitting a program via a network such as the internet or a communication line such as a telephone line and media which holds the program for a certain period of time as a volatile memory in the interior of the computer system which serves as a sever or a client in the same case. The above-described program may be the program which realizes part of the functions as describe above, and may also be a program which may realize the above-described functions in combination with the program recorded already in in the computer system.

Although the embodiment has been described as far, the invention is not limited to the embodiment, and various modifications may be made within the scope of the invention. For example, the contents to be displayed on the display unit 60 are not limited to the example described above, and any contents to be displayed may be employed as long as they are contents to be displayed which may let the user know whether the electric power generated by the power generating unit 10 is used for the operation, contents to be displayed which may let the user know whether the power stored in the power storage unit 20 is used for the operation, contents to be displayed which may let the user know the amount of electric power generated by the power generating unit 10, or contents to be displayed which may let the user know the amount of electric power stored in the power storage unit 20. Also, in the embodiment described above, the electronic timepiece 1 has been employed as an example of the electronic apparatus as shown in FIG. 1. However, any type of electronic apparatus is applicable.

What is claimed is:

1. An electronic apparatus comprising:
a power generating unit configured to generate electric power according to light incident on a light-receiving surface;
a power storing unit configured to store the electric power generated by the power generating unit and output the stored power;
a generated power voltage detecting unit configured to detect a voltage of the electric power generated by the power generating unit;
a stored power voltage detecting unit configured to detect a voltage of the electric power output from the power storage unit;
a display unit configured to display a character and a graphic; and
a display control unit configured to change contents to be displayed on the display unit on the basis of the voltage of the electric power generated by the power generating unit detected by the generated power voltage detecting unit and the voltage of the electric power output from the power storage unit detected by the stored power voltage detecting unit.

2. The electronic apparatus according to claim 1, wherein the display control unit changes the contents to be displayed on the display unit on the basis of whether or not the voltage of the electric power generated by the power generating unit is not lower than a voltage which can charge the power charging unit.

3. The electronic apparatus according to claim 1, comprising a timepiece unit configured to output information which indicates time of day;
wherein the display control unit changes the contents to be displayed on the display unit on the basis of whether or not the voltage of the electric power output from the power storage unit is equal to or higher than a voltage which is sufficient for controlling the display unit to display the time of day on the basis of the information indicating the time of day.

4. The electronic apparatus according to claim 2, comprising a timepiece unit configured to output information which indicates time of day;
wherein the display control unit changes the contents to be displayed on the display unit on the basis of whether or not the voltage of the electric power output from the power storage unit is equal to or higher than a voltage which is sufficient for controlling the display unit to display the time of day on the basis of the information indicating the time of day.

5. The electronic apparatus according to claim 3, wherein the display control unit causes the display unit to display the time of day when the voltage of the electric power output from the power storage unit is not lower than the voltage sufficient for controlling the display unit to display the time of day on the basis of the information indicating the time of day, and does not cause the display unit to display the time of day when the voltage of the electric power output from the power storage unit is lower than the voltage which is sufficient for displaying the time of day on the basis of the information indicating the time of day.

6. The electronic apparatus according to claim 4, wherein the display control unit causes the display unit to display the time of day when the voltage of the electric power output from the power storage unit is not lower than the voltage sufficient for controlling the display unit to display the time of day on the basis of the information indicating the time of day, and does not cause the display unit to display the time of day when the voltage of the electric power output from the power storage unit is lower than the voltage which is sufficient for displaying the time of day on the basis of the information indicating the time of day.

7. The electronic apparatus according to claim 1, wherein the display control unit causes the display unit to display a character or a graphic indicating the fact that the power storage unit can be charged when the voltage of the electric power generated by the power generating unit is not lower than the voltage which can charge the power charging unit.

8. The electronic apparatus according to claim 2, wherein the display control unit causes the display unit to display a character or a graphic indicating the fact that the power storage unit can be charged when the voltage of the electric power generated by the power generating unit is not lower than the voltage which can charge the power charging unit.

9. The electronic apparatus according to claim 3, wherein the display control unit causes the display unit to display a character or a graphic indicating the fact that the power storage unit can be charged when the voltage of the electric power generated by the power generating unit is not lower than the voltage which can charge the power charging unit.

10. The electronic apparatus according to claim 4, wherein the display control unit causes the display unit to display a character or a graphic indicating the fact that the power storage unit can be charged when the voltage of the electric power generated by the power generating unit is not lower than the voltage which can charge the power charging unit.

11. The electronic apparatus according to claim 5, wherein the display control unit causes the display unit to display a character or a graphic indicating the fact that the power storage unit can be charged when the voltage of the electric power generated by the power generating unit is not lower than the voltage which can charge the power charging unit.

12. The electronic apparatus according to claim 6, wherein the display control unit causes the display unit to display a character or a graphic indicating the fact that the power storage unit can be charged when the voltage of the electric power generated by the power generating unit is not lower than the voltage which can charge the power charging unit.

13. The electronic apparatus according to claim 7, wherein the display control unit changes the shape of the character or the graphic indicating the fact that the power storage unit can be charged according to the amount of electric power generated by the power generating unit.

14. The electronic apparatus according to claim 8, wherein the display control unit changes the shape of the character or the graphic indicating the fact that the power storage unit can be charged according to the amount of electric power generated by the power generating unit.

15. The electronic apparatus according to claim 9, wherein the display control unit changes the shape of the character or the graphic indicating the fact that the power storage unit can be charged according to the amount of electric power generated by the power generating unit.

16. The electronic apparatus according to claim 10, wherein the display control unit changes the shape of the character or the graphic indicating the fact that the power storage unit can be charged according to the amount of electric power generated by the power generating unit.

17. The electronic apparatus according to claim 3, wherein the display control unit changes a method of display for displaying the time of day according to the amount of electric power generated by the power generating unit.

18. The electronic apparatus according to claim 1, wherein the display control unit changes the contrast of contents to be displayed on the display unit on the basis of the voltage of the electric power generated by the power generating unit detected by the generated power voltage detecting unit and the voltage of the electric power output from the power storage unit detected by the stored power voltage detecting unit.

19. An electronic timepiece comprising:
a power generating unit configured to generate electric power according to light incident on a light-receiving surface;
a power storing unit configured to store the electric power generated by the power generating unit and output the stored power;
a generated power voltage detecting unit configured to detect a voltage of the electric power generated by the power generating unit;
a stored power voltage detecting unit configured to detect a voltage of the electric power output from the power storage unit;
a timepiece unit configured to output information which indicates time of day;
a display unit configured to display time of day, a character and a graphic; and
a display control unit configured to change contents to be displayed on the display unit on the basis of the voltage of the electric power generated by the power generating unit detected by the generated power voltage detecting unit and the voltage of the electric power output from the power storage unit detected by the stored power voltage detecting unit.
